(19) United States
(12) Patent Application Publication
(10) Pub. No.: US 2015/0362982 A1
(43) Pub. Date: Dec. 17, 2015

(54) SERVER SYSTEM AND CLUSTER SYSTEM USING THE SAME

(71) Applicants: INVENTEC (PUDONG) TECHNOLOGY CORPORATION, Shanghai (CN); INVENTEC CORPORATION, Taipei City (TW)

(72) Inventor: XIONG-JIE YU, Shanghai (CN)

(21) Appl. No.: 14/473,284

(22) Filed: Aug. 29, 2014

(30) Foreign Application Priority Data
Jun. 17, 2014 (CN) 201410270652.7

(51) Int. Cl. G06F 1/32

(52) U.S. Cl. CPC G06F 1/3287; G06F 1/3293

(57) ABSTRACT

A server system and cluster system using the same. The server system includes power supply module for providing first operation power, an energy-storing module for providing a stored power, power management module coupled to power supply module and energy-storing module for receiving first operation power and providing a second operation power, or for receiving the stored power and providing a third operation power, at least one motherboard having internal memory module for receiving second operation power or third operation power, and an external memory module coupled to the at least one motherboard. The present invention retains the data in the memory and the operating messages while a power failure occurs suddenly in the server so that server system is capable of restoring the data and the operating messages before the power failure to simplify the system and reduce the cost.

### FIELD OF THE INVENTION

The present invention relates to a cluster system, and more particularly to a server system and cluster system using the same for retaining the data in the memory and the operating messages of the motherboard while a power failure occurs suddenly in the cluster system.

### BACKGROUND OF THE INVENTION

With the rapid development of computer system technology, there is the continuous technological advancement of hardware equipment with high computing performance. Currently, cluster system is widely applicable to high performance computing field increasingly. Since the computer processes the data for various application fields by the programs, it is very important to protect the computer data due to unforeseen events. Particularly, it is required to protect the computer data during the power failure, e.g. the power down event of an external alternative current source. Conventional computer data protection is implemented by automatic saving using application programs. In other words, the application program saves the processed computer data at regular intervals. If the application program irregularly shuts down, the prior saved computer data before the application program execution is closed may be restored. However, since not all the application programs serve the functions of automatic saving, the computer data accessed by in the application program without the functions of automatic saving will be lost while the sudden power failure of the system occurs, which results in unnecessary losses of the user. On the other hand, in view of the application program with automatic saving, the protection degree of the computer data is limited to the time intervals of automatic saving. Thus, if the power failure occurs in the next saving interval, a portion of computer data will be lost without the auto-saving in time. The effect of the auto-saving function does not attain an ideal standard.

Referring to FIG. 1, it is a schematic view of a conventional structure feature “2U” or “4U” in the cluster system. The power distribution board (PBD) 12 transforms the power of the power supply unit (PSU) 11 into the voltages for the motherboards 13. The internal memory module 131 in each of the motherboards 13 stores the data of the computing results and service information of the cluster system. The operation tasks of the application program are also stored in the internal memory module 131. Since the memory is volatile component, all the memory data of the motherboards and the operation tasks cannot be stored while the power failure of the cluster system occurs. The data loss may cause the cluster system crash. Conventionally, the internal memory modules 131 in each of the motherboards 13 are replaced by Nonvolatile Dual Inline Memory Modules (NVDIMM). Because each motherboard includes a plurality of internal memory modules 131 and only if the cluster system installed with the NVDIMM of internal memory modules 131 saves the memory data and the operation tasks, it is necessary to replace all the internal memory modules 131. However, the technology of NVDIMM is incomplete and the cost of the NVDIMM is very expensive to significantly exceeding the cost of the cluster system, causing this kind of implement lower.

### SUMMARY OF THE INVENTION

Since all the memory data of the motherboards and the operation tasks cannot be stored while the power failure (e.g. alternative current power failure) of the server system occurs, one objective of the present invention is provides a server system to backup the memory data and the current operation tasks to the external storage module when the sudden power failure of the server system occurs so that the server system returns the normal status before the server system is powered off abnormally.

According to the above objective, the present invention sets forth a server system comprising: a power supply module, for providing a first operation power; an energy-storing module, for providing a stored power; a power management module electrically coupled to the power supply module and the energy-storing module, either for receiving the first operation power to provide a second operation power or for receiving the stored power to provide a third operation power; at least one motherboard comprising an internal memory module, for receiving either the second operation power or the third operation power; and an external memory module electrically coupled to the at least one motherboard; wherein when the server system operates normally, the power management module transforms the received first operation power into the second operation power to be provided to the at least one motherboard, when the server system is powered off abnormally, the power management module instantly changes the received first operation power to the stored power to transform the stored power into the third operation power, and the third operation power is provided for a time interval “T”; and wherein during the time interval “T”, a data backup module installed in an operating system is used to backup data of the internal memory module and an operation task to the external memory module while the data backup module interrupts an electrical connection between the energy-storing module and the power management module, and when the server system powers on again, the data backup module restores the data in the external memory module and operation tasks to the internal memory module so that the server system returns a normal status before the server system is powered off abnormally.

In one embodiment, the energy-storing module is either supercapacitor or a storage battery set.

In one embodiment, the external memory module is a solid state disk (SSD).

In one embodiment, the power management module comprises: a power distribution module, for transforming a power; and a real-time power supply switch module coupled to the energy-storing module, the power supply module and the power distribution module; wherein when the power supply module operates normally, the power supply module is electrically coupled to the power distribution module and the power distribution module provides the second operation power; and wherein when the power supply module is powered off abnormally, the real-time power supply switch module changes an electrical connection of the power distribution module from the power supply module to the energy-storing module so that the energy-storing module utilizes the power distribution module to provide the third operation power.

In one embodiment, the power management module further comprises a charge control module coupled to the power supply module and the energy-storing module for protecting a charging process of the power supply module and the energy-storing module.

In one embodiment, the charge control module comprises: an over-current protection unit coupled to the power supply module; a voltage-detecting unit coupled to the power supply module; a third switch unit coupled to the over-current protection unit and the energy-storing module; and a power control chip electrically coupled to the over-current protection unit, the voltage-detecting unit, third switch unit and the energy-storing module, wherein based on at least one of a detected current magnitude of the over-current protection unit, an over-voltage status and a under-voltage status of the voltage-detecting unit, and feedback information of the energy-storing module, the third switch unit is controlled to be activated or inactivated so that the power supply module enables or disables a charging procedure of the energy-storing module.

In one embodiment, the charge control module further comprises a management information unit electrically coupled to the power control chip for sending status information of the power control chip and controlling the power control chip based on received information.

In one embodiment, the charge control module further comprises an enabling signal unit electrically coupled to the power control chip for controlling the power control chip to be activated or activated.

In one embodiment, the real-time power supply switch module comprises: a first switch unit electrically coupled to the power supply module and the power distribution module, wherein when the power supply module operates normally to provides the power, the power supply module outputs a first signal to activate the first switch unit so that the power supply module controls the power distribution module to provide the second operation power to the at least one motherboard, and when the power supply module is powered off abnormally, the power supply module outputs a second signal to inactivate the first switch unit; an inverse phase unit electrically coupled to the power supply module, wherein when the power supply module normally provides the power, the inverse phase unit inverses the first signal from the power supply module to generate an inversed first signal, and when the power supply module is powered off abnormally, the inverse phase unit inverses the second signal from the power supply module to generate an inversed second signal; and a second switch unit electrically coupled to the energy-storing module, the inverse phase unit and the power distribution module, wherein when the power supply module normally provides the power, the inverse phase unit employs the inversed first signal to inactivate the second switch unit, and when the power supply module is powered off abnormally, the inverse phase unit employs the inversed second signal to activate the second switch unit so that the energy-storing module controls the power distribution module to provide the third operation power to the at least one motherboard.

In one embodiment, the real-time power supply switch module further comprises a voltage division unit coupled to the power supply module for dividing an output signal of the power supply module into either the first signal or the second signal to be provided to the first switch unit and the inverse phase unit.

In one embodiment, the energy-storing module provides the power to the inverse phase unit.

In one embodiment, the real-time power supply switch module comprises: an inverse phase unit electrically coupled to the power supply module, wherein when the power supply module normally provides the power, the inverse phase unit inverses the first signal from the power supply module to generate an inversed first signal, and when the power supply module is powered off abnormally, the inverse phase unit inverses the second signal from the power supply module to generate an inversed second signal; a first switch unit electrically coupled to the inverse phase unit, the power supply module and the power distribution module respectively, wherein when the power supply module normally provides the power, the inverse phase unit employs the inversed first signal to activate the first switch unit so that the power supply module controls the power distribution module to provide the second operation power to the at least one motherboard, and when the power supply module is powered off abnormally, the power supply module outputs the inversed second signal of the inverse phase unit for inactivating the first switch unit; and a second switch unit electrically coupled to the energy-storing module, the power supply module and the power distribution module, wherein when the power supply module normally provides the power, the power supply module outputs the first signal to inactivate the second switch unit, and when the power supply module is powered off abnormally, the power supply module outputs the second signal to activate the second switch unit so that the energy-storing module controls the power distribution module to provide the third operation power to the at least one motherboard.

In one embodiment, the real-time power supply switch module further comprises a voltage division unit electrically coupled to the power supply module for dividing an output signal of the power supply module into either the first signal or the second signal to be provided to the inverse phase unit and the second switch unit.

In one embodiment, the energy-storing module provides the power to the inverse phase unit.

In another embodiment, since all the memory data of the motherboards and the operation tasks cannot be stored while the power failure (e.g. alternative current power failure) of the cluster system occurs, one objective of the present invention is provides a server system to backup the memory data and the current operation tasks to the external storage module when the sudden power failure of the server system occurs so that the cluster system returns the normal status before the cluster system is powered off abnormally. In the server system and the cluster system of the present invention, the backup server instantly takes over the data and operation tasks of the malfunction server and need not load the application program again so that the application program executed in the cluster system is taken over seamlessly.

The cluster system comprises: a plurality of server nodes, each of the server nodes comprising: a power supply module, for providing a first operation power; an energy-storing module, for providing a stored power; a power management module electrically coupled to the power supply module and the energy-storing module, either for receiving the first operation power to provide a second operation power or for receiving the stored power to provide a third operation power; at least one motherboard comprising an internal memory module, for receiving either the second operation power or the third operation power; and

at least one storage server electrically coupled to the server nodes; wherein when the server node operates normally, the power management module transforms the received first operation power into the second operation power to be provided to the at least one motherboard, when the server system is powered off abnormally, the power management module instantly changes the received first operation power to the stored power and transforms the stored power into the third operation power, and the third operation power is provided for a time interval “T”; and

wherein during the time interval “T”, a data backup module installed in an operating system (OS) is used to backup data of the internal memory module and an operation task to the storage server while the data backup module interrupts an electrical connection between the energy-storing module and the power management module, a data restoring module in the OS of another server node receives and loads backup data in the internal memory module of the storage server and the operation task, and the another server node continuously operates at a status when the server node is powered off abnormal so that an application program executed in the cluster system is taken over seamlessly.

The advantages of the present invention comprises: backuping the memory data and the current operation tasks to the external storage module when the sudden power failure of the server system occurs so that the server system returns the normal status before the server system is powered off abnormally, which the server system involves fewer changes, a simplified structure and decreases the cost; and backuping the memory data and the current operation tasks to the external storage module when the sudden power failure of the server system occurs so that the cluster system returns the normal status before the cluster system is powered off abnormally, and in the server system and the cluster system of the present invention, the backup server instantly takes over the data and operation tasks of the malfunction server and need not load the application program again so that the application program executed in the cluster system is taken over seamlessly, which the cluster system involves fewer changes, a simplified structure and decreases the cost.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic view of a conventional cluster system;

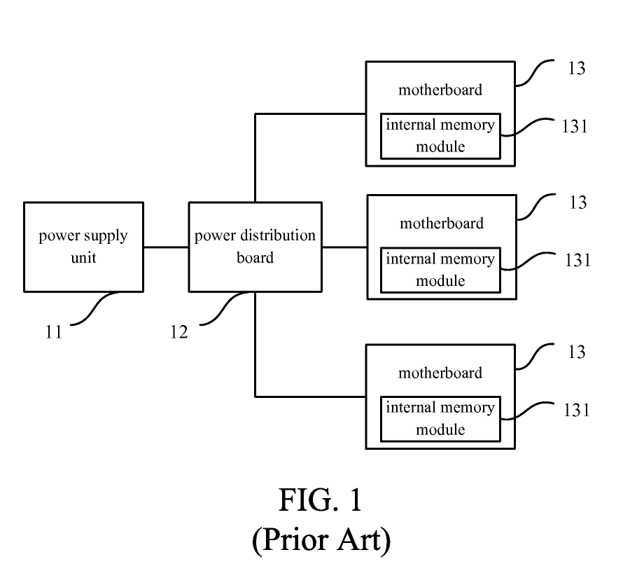

FIG. 2 is a schematic view of a server system according to first embodiment of the present invention;

FIG. 3 is a schematic view of a server system according to second embodiment of the present invention;

FIG. 4 is a schematic view of a server system according to third embodiment of the present invention;

FIG. 5 is a schematic view of a server system according to fourth embodiment of the present invention; and

FIG. 6 is a schematic view of a cluster system according to one embodiment of the present invention.

### DETAILED DESCRIPTION OF THE PREFERRED EMBODIMENTS

The following detailed descriptions of server system and cluster system using the same are mentioned below when taken in conjunction with the accompanying drawings.

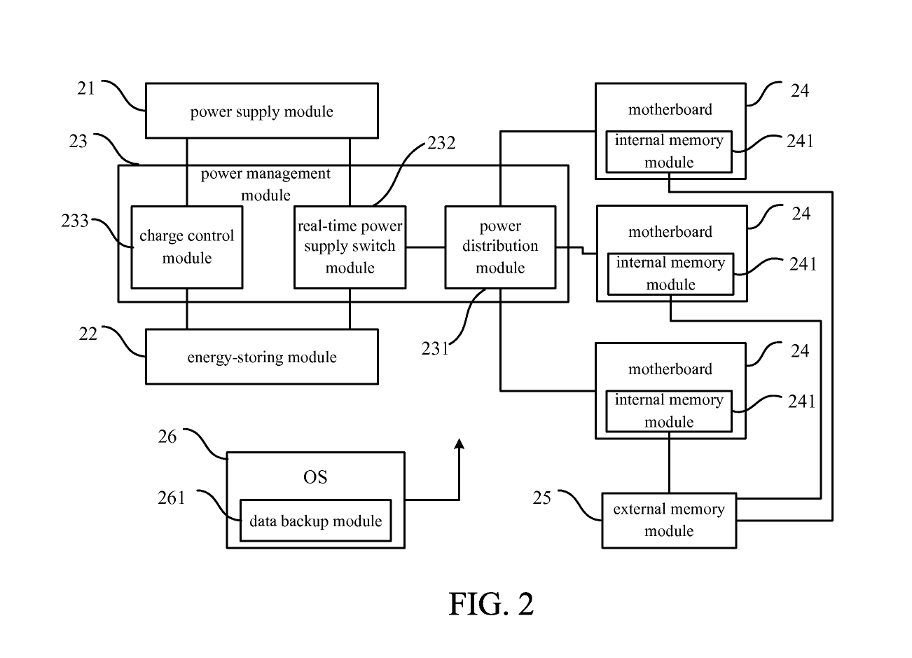

FIG. 2 is a schematic view of a server system according to first embodiment of the present invention. The server system includes a power supply module 21, an energy-storing module 22, a power management module 23, at least one motherboard 24 and an external memory module 25. The power supply module 21 provides a first operation power and the energy-storing module 22 provides a stored power. The power management module 23 electrically coupled to power supply module 21 and energy-storing module 22 receives first operation power and provides a second operation power, or receives the stored power and provides a third operation power. The at least one motherboard 24 including the internal memory module 241 receives second operation power or third operation power. The internal memory module 241 stores the memory data. The external memory module 25 is electrically coupled to the at least one motherboard 24.

When the server system operates normally, the power management module 23 transforms the received first operation power into the second operation power to be provided to the at least one motherboard 24. When the server system is powered off abnormally, e.g. a power down event of an external alternative current source, the power management module 23 instantly changes the received first operation power to the stored power and transforms the stored power into third operation power. A data backup module 261 installed in the operating system (OS) is used to backup the data of internal memory module 241 and the operation tasks to the external memory module 25. Meanwhile, the data backup module 261 interrupts the electrical connection between the energy-storing module 22 and the power management module 23. When the server system powers on again, the data backup module 261 restores the data in the external memory module 25 and operation tasks to the internal memory module 241 so that the server system returns the normal status before the server system is powered off abnormally. In this embodiment, the data backup module 261 is implemented by software program to backup the data and operation tasks.

The energy-storing module 22 is supercapacitor, i.e. electrochemical capacitors or storage battery set. The external memory module 25 is implemented by solid state disk (SSD), which is a disk composed of a plurality of electronic storage chips. Since the bandwidth of the SSD is wider, the storing speed is faster to backup the data in the internal memory module 241 and the operation tasks within a relatively short time. Further, the internal memory module 241 only needs a SSD disk, which is easily implemented and causes the cost reductions. The time interval “T” is determined by the reliable power supply time of the energy-storing module 22, the backup storing speed and the data content for ten or more seconds to perform the backup operation.

In one embodiment, the power management module 23 includes a power distribution module 231 for transforming the power and a real-time power supply switch module 232 coupled to the energy-storing module 22, power supply module 21 and the power distribution module 231. When the power supply module 21 operates normally, the power supply module 21 is electrically coupled to the power distribution module 231 and the power distribution module 231 provides the second operation power. When the power supply module 21 is powered off abnormally, the real-time power supply switch module 232 changes the electrical connection of the power distribution module 231 from the power supply module 21 to the energy-storing module 22 so that the energy-storing module 22 utilizes the power distribution module 231 to provide the third operation power.

The energy-storing module 22 is supercapacitor, i.e. electrochemical capacitors or storage battery. When the power supply module 21 operates normally, the power supply module 21 charges the energy-storing module 22. For the purpose of controlling the charge process to prevent from inverse current, over-current, over-voltage and to protect the charging process of the power supply module 21 and the energy-storing module 22, the power management module 23 further preferably includes a charge control module 233 coupled to the power supply module 21 and the energy-storing module 22 for protecting the charging process of the power supply module 21 and the energy-storing module 22.

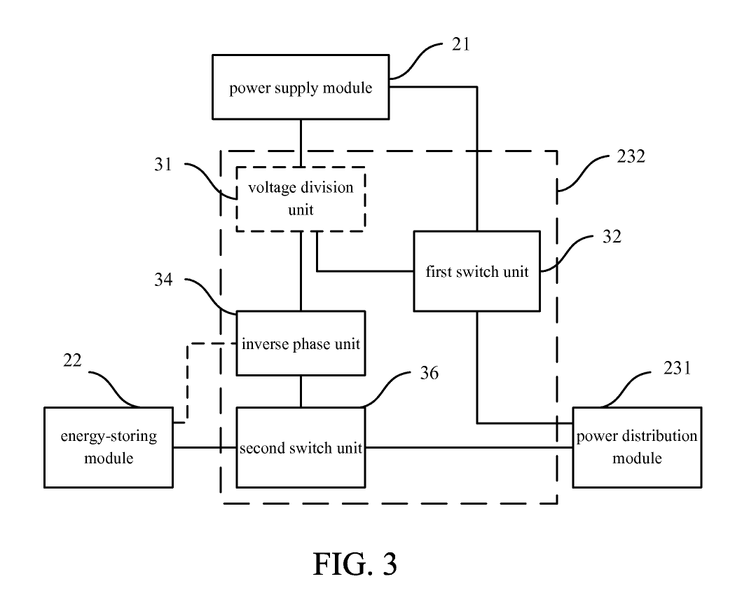

FIG. 3 is a schematic view of a server system according to second embodiment of the present invention. FIG. 3 illustrates the power supply module 21, energy-storing module 22, the power distribution module 231 and the real-time power supply switch module 232 of the power management module 23, and the connection relationship therebetween. Other components and connection relationship of the server system are shown in FIG. 2. The real-time power supply switch module 232 includes a first switch unit 32, inverse phase unit 34 and second switch unit 36. When the power supply module 21 operates normally, the first signal is outputted and when the power supply module 21 is powered off abnormally, the second signal is outputted. The first and second signals are used to control the on/off statuses of the first switch unit 32 and the second switch unit 36. In one embodiment, the first signal and the second signal are inversed signals or high/low level signals respectively, but not limited.

In another embodiment, the real-time power supply switch module 232 in the server system of FIG. 3 further includes a voltage division unit 31, the dashed line representing the optional component, coupled to the power supply module 21 for dividing the output signal of the power supply module 21 into either the first signal or the second signal to be provided to the first switch unit 32 and the inverse phase unit 34. In one case, when the outputting characteristic of the power supply module 21 is matched with the inputting characteristics of the first switch unit 32 and the inverse phase unit 34, there is no need to divide the outputting signal of the power supply module 21.

The first switch unit 32 is electrically coupled to the voltage division unit 31 and the power distribution module 231 respectively and the first switch unit 32 is directly coupled to the power supply module 21 if the voltage division unit 31 is removed. When the power supply module 21 operates normally to provides the power, the power supply module 21 outputs the first signal to activate the first switch unit 32 so that the power supply module 21 controls the power distribution module 231 to provide the second operation power to the at least one motherboard 24. In one embodiment, the first switch unit 32 may be metal-oxide-semiconductor field-effect transistor (MOSFET) to be turned on/off based on the output signal of the power supply module 21. For example, MOSFET turns on by a triggering signal with a high level. When the power supply module 21 normally provides the power and outputs the high level signal (i.e. first signal), the first switch unit 32 is activated so that the power supply module 21 controls the power distribution module 231 to provide the second operation power to the at least one motherboard 24. When the power supply module 21 is powered off abnormally and outputs the low level signal (i.e. second signal), the first switch unit 32 is inactivated so that the power supply module 21 controls the power distribution module 231 to stop to provide the second operation power to the at least one motherboard 24.

The inverse phase unit 34 is electrically coupled to the voltage division unit 31 for inversing the output signal of the power supply module 21, and the inverse phase unit 34 is directly coupled to the power supply module 21 if the voltage division unit 31 is removed. When the power supply module 21 normally provides the power, the inverse phase unit 34 inverses the first signal from the power supply module 21 to generate an inversed first signal. When the power supply module 21 is powered off abnormally, the inverse phase unit 34 inverses the second signal from the power supply module 21 to generate an inversed second signal.

The second switch unit 36 is electrically coupled to the energy-storing module 22, the inverse phase unit 34 and the power distribution module 231. When the power supply module 21 normally provides the power, the inverse phase unit 34 employs the inversed first signal to inactivate the second switch unit 36. When the power supply module 21 is powered off abnormally, the inverse phase unit 34 employs the inversed second signal to activate the second switch unit 36 so that the energy-storing module 22 controls the power distribution module 231 to provide the third operation power to the at least one motherboard 24. In one embodiment, the first switch unit 32 may be metal-oxide-semiconductor field-effect transistor (MOSFET) to be turned on/off based on the inversed output signal by inversing the output signal of the power supply module 21 via the inverse phase unit 34. For example, MOSFET turns on by a triggering signal with a high level. When the power supply module 21 normally provides the power and outputs the high level signal (i.e. first signal), the inverse phase unit 34 inverses the high level signal and outputs the low level signal to the second switch unit 36 for inactivating the second switch unit 36. When the power supply module 21 is powered off abnormally and outputs the low level signal (i.e. second signal), the inverse phase unit 34 inverses the high level signal and outputs the high level signal to the second switch unit 36 for activating the second switch unit 36 so that the energy-storing module 22 controls the power distribution module 231 to provide the third operation power to the at least one motherboard 24.

In one embodiment, the inverse phase unit 34 is further coupled to the energy-storing module 22. When the power supply module 21 is powered off abnormally, the energy-storing module 22 provides the power to the inverse phase unit 34. The inverse phase unit 34 inverses the low level signal into high level signal for controlling the second switch unit 36 to be activated wherein the output signal is divided into the low level signal because the power failure of the power supply module 21 occurs. In another embodiment, the inverse phase unit 34 may be adopts different power supplying modes.

In one embodiment, when the power supply module 21 normally provides the power, the first switch unit 32 is activated and the second switch unit 36 is inactivated so that the power supply module 21 controls the power distribution module 231 to provide the second operation power to the at least one motherboard 24. When the power supply module 21 is powered off abnormally, the first switch unit 32 is inactivated and the inverse phase unit 34 inverses the low level signal to activate the second switch unit 36 so that the energy-storing module 22 controls the power distribution module 231 to provide the third operation power to the at least one motherboard 24.

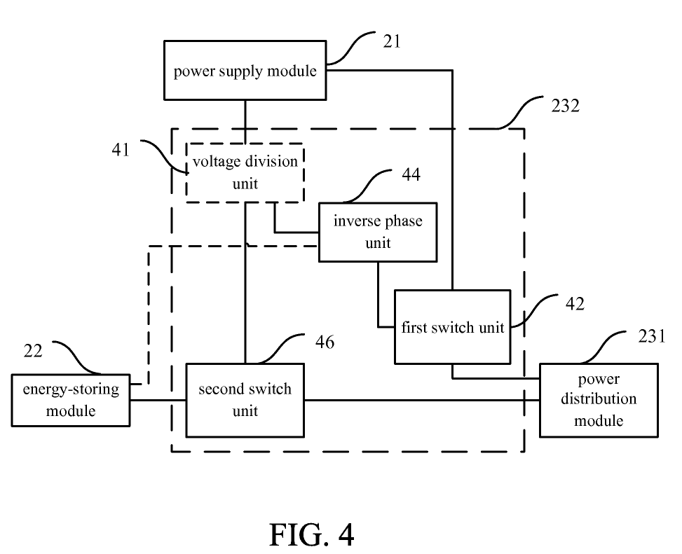

FIG. 4 is a schematic view of a server system according to third embodiment of the present invention. FIG. 4 illustrates the power supply module 21, energy-storing module 22, the power distribution module 231 and the real-time power supply switch module 232 of the power management module 23, and the connection relationship therebetween. Other components and connection relationship of the server system are shown in FIG. 2. The real-time power supply switch module 232 includes a first switch unit 42, inverse phase unit 44 and second switch unit 46. When the power supply module 21 operates normally, the first signal is outputted and when the power supply module 21 is powered off abnormally, the second signal is outputted. The first and second signals are used to control the on/off statuses of the first switch unit 42 and the second switch unit 46. In one embodiment, the first signal and the second signal are inversed signals or high/low level signals respectively, but not limited.

In another embodiment, the real-time power supply switch module 232 in the server system of FIG. 4 further includes a voltage division unit 41 (the dashed line representing the optional component) coupled to the power supply module 21 for dividing the output signal of the power supply module 21 into the first signal and the second signal to be provided to the inverse phase unit 44 and the second switch unit 46. In one case, when the outputting characteristic of the power supply module 21 is matched with the inputting characteristics of the inverse phase unit 44 and the second switch unit 46, there is no need to divide the outputting signal of the power supply module 21.

The inverse phase unit 44 is electrically coupled to the voltage division unit 41 and the power distribution module 231 respectively and the inverse phase unit 44 is directly coupled to the power supply module 21 if the voltage division unit 41 is removed. When the power supply module 21 normally provides the power, the inverse phase unit 44 inverses the first signal from the power supply module 21 to generate an inversed first signal. When the power supply module 21 is powered off abnormally, the inverse phase unit 44 inverses the second signal from the power supply module 21 to generate an inversed second signal.

The first switch unit 42 is electrically coupled to the inverse phase unit 44 and the power distribution module 231 respectively. When the power supply module 21 normally provides the power, the inverse phase unit 44 employs the inversed first signal to activate the first switch unit 42 so that the power supply module 21 controls the power distribution module 231 to provide the second operation power to the at least one motherboard 24. In one embodiment, the first switch unit 42 may be metal-oxide-semiconductor field-effect transistor (MOSFET) to be turned on/off based on the output signal of the inverse phase unit 44. For example, MOSFET turns on by a low level signal. When the power supply module 21 normally provides the power and outputs the high level signal (i.e. first signal), the inverse phase unit 44 inverses the high level signal into a low level signal which is provided to the first switch unit 42 for activating the first switch unit 42 so that the power supply module 21 controls the power distribution module 231 to provide the second operation power to the at least one motherboard 24. When the power supply module 21 is powered off abnormally and outputs the low level signal (i.e. second signal), the inverse phase unit 44 inverses the low level signal into a high level signal which is provided to the first switch unit 42 for inactivating the first switch unit 42 so that the power supply module 21 controls the power distribution module 231 to stop to provide the second operation power to the at least one motherboard 24.

The second switch unit 46 is electrically coupled to the voltage division unit 41, energy-storing module 22 and the power distribution module 231 and the second switch unit 46 is directly coupled to the power supply module 21 if the voltage division unit 41 is removed. When the power supply module 21 normally provides the power, the power supply module 21 outputs the first signal to inactivate the second switch unit 46. When the power supply module 21 is powered off abnormally, the power supply module 21 outputs the second signal to activate the second switch unit 46 so that the energy-storing module 22 controls the power distribution module 231 to provide the third operation power to the at least one motherboard 24. In one embodiment, the second switch unit 46 may be metal-oxide-semiconductor field-effect transistor (MOSFET) to be turned on/off based on the output signal of the power supply module 21. For example, MOSFET turns on by a low level signal. When the power supply module 21 normally provides the power and outputs the high level signal (i.e. first signal), the inverse phase unit 34 inverses the high level signal and outputs the low level signal to the second switch unit 36 for inactivating the second switch unit 36. When the power supply module 21 is powered off abnormally and outputs the low level signal (i.e. second signal), the second switch unit 46 is activated so that the energy-storing module 22 controls the power distribution module 231 to provide the third operation power to the at least one motherboard 24.

In one embodiment, the inverse phase unit 44 is further coupled to the energy-storing module 22. When the power supply module 21 is powered off abnormally, the energy-storing module 22 provides the power to the inverse phase unit 44. The inverse phase unit 44 inverses the low level signal into high level signal for controlling the first switch unit 42 to be inactivated wherein the output signal is divided into the low level signal because the power failure of the power supply module 21 occurs. In another embodiment, the inverse phase unit 44 may be adopts different power supplying modes.

In one embodiment, when the power supply module 21 normally provides the power, the inverse phase unit 44 inverses the high level signal into low level signal to activate the first switch unit 42 and the second switch unit 46 is inactivated so that the power supply module 21 controls the power distribution module 231 to provide the second operation power to the at least one motherboard 24. When the power supply module 21 is powered off abnormally, the first switch unit 42 is inactivated and the second switch unit 46 is activated so that the energy-storing module 22 controls the power distribution module 231 to provide the third operation power to the at least one motherboard 24.

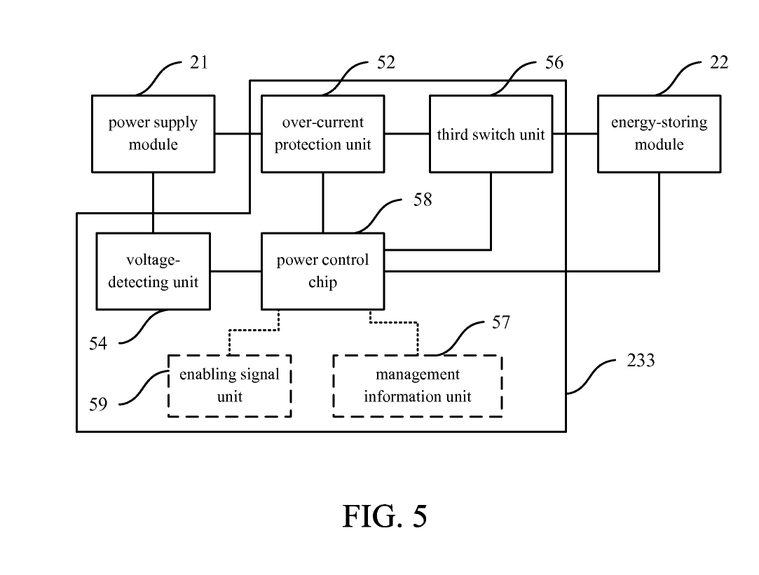

FIG. 5 is a schematic view of a server system according to fourth embodiment of the present invention. FIG. 5 illustrates the power supply module 21, energy-storing module 22, charge control module 233, and the connection relationship therebetween. Other components and connection relationship of the server system are shown in FIG. 2. The charge control module 233 is electrically coupled to the power supply module 21 and the energy-storing module 22 for controlling the charging procedure. In this case, the charge control module 233 includes an over-current protection unit 52, a voltage-detecting unit 54, a third switch unit 56 and a power control chip 58.

The over-current protection unit 52 is electrically coupled to the power supply module 21 for detecting the current magnitude transmitted from the power supply module 21 and for sending the detecting result to the power control chip 58 which is one of control parameters for turning on the third switch unit 56. The voltage-detecting unit 54 is electrically coupled to the power supply module 21 for detecting the over-voltage (OV) and the under-voltage (UV) statuses of the power supply module 21 and for sending the detecting result to the power control chip 58 which is one of control parameters for turning on the third switch unit 56. The third switch unit 56 is electrically coupled to the over-current protection unit 52 and the energy-storing module 22. The power control chip 58 is electrically coupled to the over-current protection unit 52, voltage-detecting unit 54, third switch unit 56 and the energy-storing module 22. Based on at least one of the detected current magnitude of over-current protection unit 52, the over-voltage and the under-voltage statuses of the voltage-detecting unit 54 and feedback information of the energy-storing module 22, the third switch unit 56 is controlled to be activated or inactivated so that the power supply module 21 enables or disables the charging procedure of the energy-storing module 22.

In one embodiment, the third switch unit 56 is composed of transistors. The power control chip 58 controls the third switch unit 56 to be activated or inactivated for turning on/off the charging power transmitted from the power supply module 21 to the energy-storing module 22.

In one embodiment, the charge control module 233 further includes a management information unit 57 where the dashed line represents the optional component. The management information unit 57 is electrically coupled to the power control chip 58 for sending the status information and controlling the power control chip 58 based on the received information. For example, the management information unit 57 employs the I²C (Inter-Integrated Circuit) protocol including serial clock line (SCL) and serial data line (SDA) and System Management Bus (SMBus) protocol for sending the status information and controlling the power control chip 58 based on the received information.

In one embodiment, the charge control module 233 further includes an enabling signal unit 59 where the dashed line represents the optional component. The enabling signal unit 59 is electrically coupled to the power control chip 58 for controlling the power control chip 58 to be activated or activated wherein the enabling signal unit 59 is controlled by external signal. In first embodiment, the resistor is pulled up to the high level signal or pulled down to low level signal to activate the power control chip 58. In second embodiment, the enabling signal unit 59 controls the power supply of the power control chip 58 to be activated or inactivated. In third embodiment, the power control chip 58 controls itself power supply based on state information. In one case, when the enabling signal unit 59 activates the power control chip 58, the power control chip 58 controls the third switch unit 56 to be activated so that the power supply module 21 charges the energy-storing module 22 if the over-current protection unit 52 detects no current magnitude, the voltage-detecting unit 54 detects no over-voltage and under-voltage statuses, and the energy-storing module 22 detects no feedback information of over-charging status.

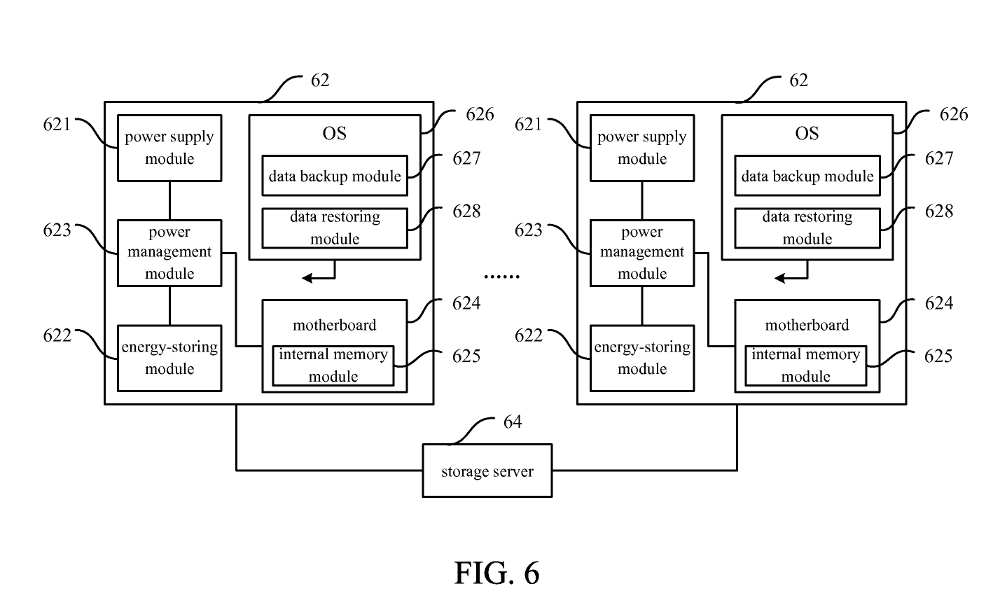

FIG. 6 is a schematic view of a cluster system according to one embodiment of the present invention. The cluster system includes a plurality of server nodes 62 and at least one storage server 64. The at least one storage server 64 is electrically coupled to the server nodes 62. Each server node 62 includes a power supply module 621, an energy-storing module 622, a power management module 623 and at least one motherboard 624. The power supply module 621 provides a first operation power and the energy-storing module 622 provides a stored power. The power management module 623 electrically coupled to power supply module 621 and energy-storing module 622 receives first operation power and provides a second operation power, or receives the stored power and provides a third operation power. The at least one motherboard 624 includes at least one internal memory module 625 for storing memory data. The at least one motherboard 624 receives the second operation power or third operation power wherein the energy-storing module 622 may be supercapacitor, i.e. electrochemical capacitors or storage battery set.

When the server node 62 operates normally, the power management module 623 transforms the received first operation power into the second operation power to be provided to the at least one motherboard 624. When the server node is powered off abnormally, the power management module 623 instantly changes the received first operation power to the stored power and transforms the stored power into third operation power. The third operation power is provided for a time interval “T”. During the time interval “T”, a data backup module 627 installed in the operating system (OS) 626 is used to backup the data of internal memory module 625 and the operation tasks to the storage server 64. Meanwhile, the data backup module 627 interrupts the electrical connection between the energy-storing module 622 and the power management module 623. A data restoring module 628 in the OS 626 of another server node 62 receives and loads the backup data in the internal memory module 625 of the storage server 64 and the operation tasks. The another server node 62 continuously operates at the status when the server node 62 is powered off abnormal so that the application program executed in the cluster system is taken over seamlessly. The data backup module 627 is implemented by software program to backup the data and operation tasks. The data restoring module 628 is implemented by software program to take over and load the backup data.

In the present invention, when the application program executed in one server of the cluster system malfunctions due to power failure, another application program in another server is capable of taking over the data in relative storage of the one server so that the function of application program in the one server works normally. Conventionally, the taking over procedure includes three steps of detecting and confirming the application program malfunction, restarting the application program by the backup server, and taking over the data in the relative storage region. In this case, it takes a long time to re-execute the another application program, which depends on the execution scale of the application program. In the server system and the cluster system of the present invention, the backup server instantly takes over the data and operation tasks of the malfunction server and it is not required to load the application program again so that the application program executed in the cluster system is taken over seamlessly.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A server system, comprising:
a power supply module, for providing a first operation power;
an energy-storing module, for providing a stored power;
a power management module electrically coupled to the power supply module and the energy-storing module, either for receiving the first operation power to provide a second operation power or for receiving the stored power to provide a third operation power;
at least one motherboard comprising an internal memory module, for receiving either the second operation power or the third operation power; and
an external memory module electrically coupled to the at least one motherboard;
wherein when the server system operates normally, the power management module transforms the received first operation power into the second operation power to be provided to the at least one motherboard, when the server system is powered off abnormally, the power management module instantly changes the received first operation power to the stored power to transform the stored power into the third operation power, and the third operation power is provided for a time interval “T”; and
wherein during the time interval “T”, a data backup module installed in an operating system is used to backup data of the internal memory module and an operation task to the external memory module while the data backup module interrupts an electrical connection between the energy-storing module and the power management module, and when the server system powers on again, the data backup module restores the data in the external memory module and operation tasks to the internal memory module so that the server system returns a normal status before the server system is powered off abnormally.

2. The server system of claim 1, wherein the energy-storing module is either supercapacitor or a storage battery set.

3. The server system of claim 1, wherein the external memory module is a solid state disk (SSD).

4. The server system of claim 1, wherein the power management module comprises:
a power distribution module, for transforming a power; and
a real-time power supply switch module coupled to the energy-storing module, the power supply module and the power distribution module;
wherein when the power supply module operates normally, the power supply module is electrically coupled to the power distribution module and the power distribution module provides the second operation power; and
wherein when the power supply module is powered off abnormally, the real-time power supply switch module changes an electrical connection of the power distribution module from the power supply module to the energy-storing module so that the energy-storing module utilizes the power distribution module to provide the third operation power.

5. The server system of claim 4, wherein the power management module further comprises a charge control module coupled to the power supply module and the energy-storing module for protecting a charging process of the power supply module and the energy-storing module.

6. The server system of claim 5, wherein the charge control module comprises:
an over-current protection unit coupled to the power supply module;
a voltage-detecting unit coupled to the power supply module;
a third switch unit coupled to the over-current protection unit and the energy-storing module; and
a power control chip electrically coupled to the over-current protection unit, the voltage-detecting unit, third switch unit and the energy-storing module, wherein based on at least one of a detected current magnitude of the over-current protection unit, an over-voltage status and a under-voltage status of the voltage-detecting unit, and feedback information of the energy-storing module, the third switch unit is controlled to be activated or inactivated so that the power supply module enables or disables a charging procedure of the energy-storing module.

7. The server system of claim 6, wherein the charge control module further comprises a management information unit electrically coupled to the power control chip for sending status information of the power control chip and controlling the power control chip based on received information.

8. The server system of claim 6, wherein the charge control module further comprises an enabling signal unit electrically coupled to the power control chip for controlling the power control chip to be activated or activated.

9. The server system of claim 4, wherein the real-time power supply switch module comprises:
a first switch unit electrically coupled to the power supply module and the power distribution module, wherein when the power supply module operates normally to provides the power, the power supply module outputs a first signal to activate the first switch unit so that the power supply module controls the power distribution module to provide the second operation power to the at least one motherboard, and when the power supply module is powered off abnormally, the power supply module outputs a second signal to inactivate the first switch unit;
an inverse phase unit electrically coupled to the power supply module, wherein when the power supply module normally provides the power, the inverse phase unit inverses the first signal from the power supply module to generate an inversed first signal, and when the power supply module is powered off abnormally, the inverse phase unit inverses the second signal from the power supply module to generate an inversed second signal; and
a second switch unit electrically coupled to the energy-storing module, the inverse phase unit and the power distribution module, wherein when the power supply module normally provides the power, the inverse phase unit employs the inversed first signal to inactivate the second switch unit, and when the power supply module is powered off abnormally, the inverse phase unit employs the inversed second signal to activate the second switch unit so that the energy-storing module controls the power distribution module to provide the third operation power to the at least one motherboard.

10. The server system of claim 9, wherein the real-time power supply switch module further comprises a voltage division unit coupled to the power supply module for dividing an output signal of the power supply module into either the first signal or the second signal to be provided to the first switch unit and the inverse phase unit.

11. The server system of claim 9, wherein the energy-storing module provides the power to the inverse phase unit.

12. The server system of claim 4, wherein the real-time power supply switch module comprises:
an inverse phase unit electrically coupled to the power supply module, wherein when the power supply module normally provides the power, the inverse phase unit inverses the first signal from the power supply module to generate an inversed first signal, and when the power supply module is powered off abnormally, the inverse phase unit inverses the second signal from the power supply module to generate an inversed second signal;
a first switch unit electrically coupled to the inverse phase unit, the power supply module and the power distribution module respectively, wherein when the power supply module normally provides the power, the inverse phase unit employs the inversed first signal to activate the first switch unit so that the power supply module controls the power distribution module to provide the second operation power to the at least one motherboard, and when the power supply module is powered off abnormally, the power supply module outputs the inversed second signal of the inverse phase unit for inactivating the first switch unit; and
a second switch unit electrically coupled to the energy-storing module, the power supply module and the power distribution module, wherein when the power supply module normally provides the power, the power supply module outputs the first signal to inactivate the second switch unit, and when the power supply module is powered off abnormally, the power supply module outputs the second signal to activate the second switch unit so that the energy-storing module controls the power distribution module to provide the third operation power to the at least one motherboard.

13. The server system of claim 12, wherein the real-time power supply switch module further comprises a voltage division unit electrically coupled to the power supply module for dividing an output signal of the power supply module into either the first signal or the second signal to be provided to the inverse phase unit and the second switch unit.

14. The server system of claim 12, wherein the energy-storing module provides the power to the inverse phase unit.

15. A cluster system, comprising:
a plurality of server nodes, each of the server nodes comprising:
a power supply module, for providing a first operation power;
an energy-storing module, for providing a stored power;
a power management module electrically coupled to the power supply module and the energy-storing module, either for receiving the first operation power to provide a second operation power or for receiving the stored power to provide a third operation power;
at least one motherboard comprising an internal memory module, for receiving either the second operation power or the third operation power; and
at least one storage server electrically coupled to the server nodes;
wherein when the server node operates normally, the power management module transforms the received first operation power into the second operation power to be provided to the at least one motherboard, when the server system is powered off abnormally, the power management module instantly changes the received first operation power to the stored power and transforms the stored power into the third operation power, and the third operation power is provided for a time interval “T”; and
wherein during the time interval “T”, a data backup module installed in an operating system (OS) is used to backup data of the internal memory module and an operation task to the storage server while the data backup module interrupts an electrical connection between the energy-storing module and the power management module, a data restoring module in the OS of another server node receives and loads backup data in the internal memory module of the storage server and the operation task, and the another server node continuously operates at a status when the server node is powered off abnormal so that an application program executed in the cluster system is taken over seamlessly.
